(19) United States
(12) Patent Application Publication
(10) Pub. No.: US 2026/0318130 A1
(43) Pub. Date: Oct. 15, 2026

(54) LOCK FOR A MOTOR VEHICLE

(71) Applicant: Kiekert Aktiengesellschaft, Heiligenhaus (DE)

(72) Inventors: Udo ORZECH, Velbert (DE); Christian STURM, Krefeld (DE)

(73) Assignee: Kiekert Aktiengesellschaft, Heiligenhaus (DE)

(21) Appl. No.: 19/101,358

(22) PCT Filed: Jul. 26, 2023
(86) PCT No.: PCT/DE2023/100552

§ 371 Date: Feb. 13, 2025

(30) Foreign Application Priority Data
Aug. 9, 2022 (DE) 10 2022 119 990.8

(51) Int. Cl. E05B 85/26; E05B 81/20; E05B 81/42; E05B 85/24

(52) U.S. Cl. CPC E05B 85/26; E05B 81/20; E05B 81/42; E05B 85/243

(57) ABSTRACT

The invention relates to a lock (1) for a motor vehicle, having a locking mechanism (2) consisting of: a rotary latch (3) and at least one pawl (4, 5), the rotary latch (3) being latchable in a pre-latch position (36) and a main latch position (37); a pre-latch pawl (4) and a main latch pawl (5), a pre-latch (17) of the locking mechanism (2) being formed by an angled region of a metal main body (18) of the rotary latch (3), and the angled region (17) being engageable with a closure pawl (25) of a closure device (23).

The invention relates to a lock for a motor vehicle having a locking mechanism consisting of a rotary latch and at least one pawl, the rotary latch being latchable in a pre-latch position and a main latch position; a pre-latch pawl and a main latch pawl, a pre-latch of the locking mechanism being formed by an angled region of a metal main body of the rotary latch.

Locks or locking devices for motor vehicles are used where pivoting or sliding components on the motor vehicle must be secured in their position. To secure the position of the components, the locking device works together with a lock holder, wherein a locking mechanism of the locking device is moved into a locked position by a relative movement of the locking device with respect to a lock holder. Areas of application for these locks include tailgates, doors and sliding doors- and also, for example, backrest locks for rear seats in vehicle interiors. The invention preferably relates to a lock for a tailgate of a motor vehicle.

In order to increase the practicality of the aforementioned locking devices, the locking systems are designed as electrically operable locking systems. Electrically actuated locking systems use electric motors that enable a locking mechanism to be unlocked, and therefore the lock to be opened electrically. In combination with, for example, a motor-operated tailgate, the operator can open the tailgate via radio remote control without having to manually intervene on the vehicle. In addition to the electrical unlocking of the locking mechanism, so-called closure devices are also used. The closure devices make it possible for a tailgate, or even a side door, once opened, to be moved into its final closed position with electrical assistance.

In order to provide this automatic closing process, the lock must be able to be moved into its final closed position. The motor vehicle lock according to the invention comprises a locking mechanism with a rotary latch and at least one pawl. The rotary latch is pivotably held on a metal lock plate and can interact with a lock holder or lock holder bracket attached to the motor vehicle via an insertion region. When the lock or tailgate or door is closed, the rotary latch is moved from an open position to a first closed position by the relative movement of the lock holder, which is usually fixed to the motor vehicle.

In a first closed position, which is called the pre-latch position, a pawl engages the rotary latch in such a way that the movement of the rotary latch is blocked. The rotary latch cannot be opened again without moving the pawl. In order to move the rotary latch from this pre-latch position to a main latch position, closure aids are used. These closure devices interact with the locking mechanism in such a way that the rotary latch is transferred from the blocked pre-latch position to a main latch position. In other words, the rotary latch is electrically assisted to move further into its closed position. The closure device moves the rotary latch into the main latch position, in which a pawl- or the same pawl-engages with the rotary latch and blocks the rotary latch in its main latch position. The rotary latch is then in the end position and the door or tailgate is in its final closed position.

In order to be able to reach the main latch position reliably, the rotary latch is moved into an over-travel position by means of the closure device. An over-travel position is one in which the rotary latch is moved further into the closed position than is necessary for the main latch pawl to engage. By moving the rotary latch into the over-travel position, it is possible to ensure that the main latch pawl is securely latched or engaged in the rotary latch. Therefore, this is necessary in particular because it must be ensured that the locking mechanism latches securely in the main latch position even when the door or tailgate is closed electrically.

As described above, a pawl must interact with the rotary latch to achieve the pre-latch position and the main latch position. In this case, it is possible for only one pawl to interact with the rotary latch, or for two or more pawls to be used—which, for example, interact with the rotary latch on different planes. It is also known that, for example, in a main latch position of the locking mechanism, there is an opening torque in the locking mechanism. Opening torque in this case means a force by which the pawl is forced out of the latching position. In order to prevent the locking mechanism from unlocking itself in this case, the pawl is additionally secured in the latching position by means of a latching or blocking lever.

A motor vehicle lock with a locking mechanism and a closure/opening device has become known from DE 10 2013 106 672 A1. The closure and opening device acts on a locking mechanism via a Bowden cable, with a gear mechanism lever being provided on the locking mechanism on which a closure pawl is pivotally mounted. By means of the closure pawl, the locking mechanism can be moved from a pre-latch position to a main latch position. As a characteristic feature, the document discloses a drive for the closure device, wherein the drive is designed torque-variable, and the gear mechanism element of the closure device is subjected to a torque depending on the drive path and consequently also to a force depending on the drive path. For this purpose, the drive unit has an electric motor with a downstream gear mechanism, whereby the gear mechanism is designed as a torque converter. This means that the drive is able to provide different forces to close the locking mechanism as required. In particular, the document has a spiral-shaped control contour which engages with the Bowden cable, wherein the Bowden cable allows a transmission of the step-wise increasing force to the locking mechanism.

The object of the invention is to provide an improved lock for a motor vehicle. In particular, it is an object of the invention to provide a compact locking system having a high level of functionality and having the smallest possible number of components.

According to the invention, the object is achieved by the features of independent claim 1. Advantageous embodiments of the invention are specified in the dependent claims. It should be noted that the exemplary embodiments described below are not restrictive; rather, any variation of the features described in the description and the dependent claims is possible.

According to claim 1, the object of the invention is achieved in that a lock for a motor vehicle is provided, having a locking mechanism with a rotary latch and at least one pawl, the rotary latch being latchable in a pre-latch position and a main latch position; a main latch pawl and a pre-latch pawl, a pre-latch of the locking mechanism being formed by a region arranged on the metallic base body of the rotary latch, in particular an angled region of a metal main body of the rotary latch, and the angled region being engageable with a closure pawl of a closure device. The inventive design of the motor vehicle lock now makes it possible to realize a compact design of a motor vehicle lock in which a high level of functionality can be achieved with a small number of components. In particular, by means of a region arranged on, preferably attached to, the rotary latch, such as a bolt or rivet bolt, and even more preferably by using the angled region of the metal main body of the rotary latch as a pre-latch and at the same time as a means of implementing a closure device for the locking mechanism, further components, moldings and/or structural means for introducing a force to close the locking mechanism can be omitted.

The closure device therefore interacts directly with the rotary latch and in particular with the engagement surface on the rotary latch, which is also used to implement the pre-latch position in the motor vehicle lock. The angled region on the rotary latch therefore has a dual function. On the one hand, the angled region can be used to implement a first latching position for closing the locking mechanism and, at the same time, the closure pawl can engage with the angled region in order to implement a complete closing and to reach the main latch position of the locking mechanism. Consequently, a high level of functionality can be provided in the motor vehicle lock with minimal design resources.

The lock according to the invention can be a lock for a tailgate, a side door, a tailgate or roof—but also, for example, for a seat back of a rear seat bench of a vehicle. The invention preferably relates specifically to a lock for a tailgate of a motor vehicle. Special requirements are placed on tailgate locks because, in contrast to sliding door locks, for example, they can be exposed to changing loads. For example, it may happen that the tailgate is loaded with snow, so that, when opening it, and in particular when opening it electrically, it must be ensured that the lock is fully open until the loaded tailgate is closed again. For example, if a tailgate is loaded with snow, the locking mechanism may be opened electrically, but the lock holder engaging with the rotary latch does not cause any relative movement in the locking mechanism because the tailgate remains in its position due to the heavy load. In this case, the pawl or pawls must be held out of engagement with the rotary latch. Keeping the pawl disengaged when the locking mechanism is unlocked is also called the snow load function.

Regarding the structure of the locking mechanism, reference should be made to the introductory explanations. The rotary latch has a metallic main body which is pivotably mounted in the vehicle lock via a metallic axle pin. The pivot axis of the rotary latch, as well as of the pawl or pawls, is also held in a metal lock case. This metallic basic structure of the motor vehicle lock can ensure that the pivoting or movable component on the motor vehicle can be held securely even in extreme situations, such as an accident. In the pre-latch and main latch, the metal regions of the pawl and the rotary latch are in contact with one another in order to ensure secure latching and, in particular, precise positioning of the locking mechanism.

According to the invention, an angled region is provided on the metallic main body of the rotary latch, wherein the angled region preferably has an angle of 90° to the base surface of the rotary latch and extends beyond the flat extension of the rotary latch. The angled region therefore forms a one-piece component with the rotary latch and engages with the pre-latch pawl.

In an advantageous embodiment variant of the invention, the closure pawl is pivotably mounted on a stationary closure aid. The closure pawl acts directly on the angled region of the metal main body of the rotary latch and is mounted in a closure aid arranged in a fixed position in the motor vehicle lock in such a way that a transmission of a closure force from a pre-latch to a main latch element is possible. By connecting to the closure lever, it is possible to influence the closure forces and to influence the closure forces with regard to the design of the closure lever. Increased forces occur particularly when the main latch position or the overtravel position is fully reached, and these forces increase continuously during the closure process. This is particularly due to the seal arranged between the moving component and the body. In order to achieve a complete seal against moisture, but also with regard to noise minimization, a seal, in particular a door or tailgate seal, is arranged between the component movably arranged on the motor vehicle and the body. The closure device must move the rotary latch against this sealing pressure, which occurs when the seal is compressed. By means of the relative movement between the rotary latch and the lock holder, the closure force is introduced into the movable component. Sealing pressures of up to 500 N can occur here, which must be transmitted to the lock holder via the closure device and the locking mechanism. Due to the advantageous mounting of the closure pawl on a closure lever, the force to be introduced into the locking mechanism can be varied depending on the size of the seal. In particular, the direct connection between the closure pawl and the angled region ensures a safe transmission of force to the rotary latch.

In an advantageous embodiment variant of the invention, the closure device acts on the rotary latch with a variable closure force. The closure pawl acts directly on the rotary latch and moves the rotary latch from the pre-latch position to the main latch position or to the overtravel position. During this closure process, a variable force acts against the rotary latch and therefore also the closure drive. In particular, the door or tailgate is moved by means of the rotary latch against the force of a seal. As the door or tailgate increasingly moves into the closed position, the sealing pressure increases and therefore also the counterforce on the rotary latch. In order to counteract this variable force with a correspondingly variable closure force, a closure force increasing with the increasing closing movement of the door or tailgate can be provided by means of the closure device. The variable closure force therefore offers the advantage that, with a constant drive torque, the force provided by the electric motor and the gear stage abutting the output shaft of the electric motor can be advantageously adapted to the required closure forces. By changing the closure force, a force or torque adapted to the closure process can be generated and transmitted to the rotary latch. The rotary latch engages with a lock holder or lock holder bracket and moves the door from the pre-latch position to the main latch position. The main latch position corresponds to the closed position of the door or tailgate in the motor vehicle.

It can also be advantageous or represent an embodiment variant of the invention if the closure lever can be driven by means of a cam disk. The closure lever can be pivoted but is fixed in place in the motor vehicle lock. A closure pawl is arranged on one side of the closure lever, which acts directly on the rotary latch. At the end of the closure lever opposite the closure pawl, the closure lever engages with a cam disk. The cam disk is designed in such a way that a variable torque can be introduced into the closure lever. Depending on the orientation and arrangement of the cam disk, the cam disk moves in the motor vehicle lock and enables closure of the locking mechanism. The cam disk is designed in such a way that, at the beginning of the closure process, the door or tailgate element moves relatively quickly with little force introduced into the closure pawl, and as the closure movement of the door or tailgate increases, the torque introduced into the closure pawl increases so that the rotary latch can be moved into the main latch position with less speed but greater force. The cam disk therefore enables an adaptation of the necessary force and at the same time an adjustment of the closing movement or closing speed of the door or tailgate. Preferably, the cam disk is arranged so as to be rotatable in the motor vehicle lock but fixed in place in the motor vehicle lock. Similarly to the closure lever, the cam disk is fixed in place in the motor vehicle lock and allows a pivoting of the closure lever, which enables an actuation of the closure pawl.

During closing, the closure lever introduces an increasing closure force into the closure pawl. In this regard, we can also speak of a progressively increasing closure force. The cam disk is designed in such a way that the force increases continuously. The path of the curve on the cam disk increases the force continuously but increasingly. The path of the curve on the cam disk can be described as helical. The helix extends from a radially outer end of the cam disk to an interior of the cam disk, i.e., the curve extends helically towards the center of the cam disk, i.e., towards the axis of rotation of the cam disk.

It can also be advantageous and form an embodiment variant of the invention if the cam disk is integrated in the motor vehicle lock. By integrating the cam disk into the motor vehicle lock or into a housing of the motor vehicle lock, it is possible to directly drive the closure lever. This offers the advantage of a compact design, wherein external drives can be omitted. The cam disk is preferably driven by means of an electric motor and via a first stage, for example a worm gear stage. However, depending on the size of the door, sliding door or tailgate, it is also conceivable that more than one gear stage is arranged between the electric drive and the cam disk. The cam disk is driven by means of the gear mechanism with a constant torque; an adjustment or increase in the force on the rotary latch is then achieved via the interaction of the cam disk and the closure lever.

Advantageously, the cam disk can have a guide contour for the closure lever. On the one hand, it is conceivable that the cam disk is formed from a control contour, with the closure lever resting on the control contour, but preferably a guide contour is used in the cam disk. For this purpose, the closure lever can have a drive bolt which is, for example, riveted to the closure lever. This drive bolt is then held in the guide contour, and the closure lever can be moved by a rotating movement of the cam disk. The closure lever pivots around its fixed pivot point. It is of course also conceivable that the drive bolt can be brought into a keyed engagement with the cam disk. A keyed engagement between the drive bolt and the guide contour can ensure a safe transmission of the torque to the closure pawl.

Advantageously, the cam disk can have a middle position, in particular a middle position as a parking position for the closure pawl. The middle position defines a parking position for the closure pawl, which can also be described as the starting position for closing. In the parking position, the closure pawl is in a position in which the closure pawl is able to fall into the locking mechanism, preferably the rotary latch and even more preferably into the pre-latch. Starting from the middle position, a closure process can be started by reaching the pre-latch and the pre-latch pawl coming into contact with the pre-latch.

It is also advantageous if the rotary latch can be moved into an overtravel position by means of the cam disk. Starting from the pre-latch position in which the closure pawl is in contact with the pre-latch on the rotary latch, the cam disk can be used to move the rotary latch. The closure lever is moved by means of the cam disk and preferably by means of the guide contour, and the closure pawl pulls or pushes the rotary latch from the pre-latch position into the main latch position. In the main latch position, the main latch pawl falls into the main latch of the rotary latch. In order to be able to safely reach the main latch position in the locking mechanism, the rotary latch is moved beyond the main latch position by means of the closure pawl so that a safe engagement of the main latch pawl into the main latch of the rotary latch can be ensured. The rotary latch is therefore rotated beyond the actual main latch position in order to achieve a secure electrically operated reaching of the main latching in the locking mechanism.

The invention is explained in more detail below with reference to the accompanying drawings on the basis of a preferred exemplary embodiment. However, the principle applies that the exemplary embodiment does not limit the invention, but is merely an advantageous design. The features depicted can be implemented individually or in combination with further features of the description as well as what is claimed-individually or in combination.

In the drawings:

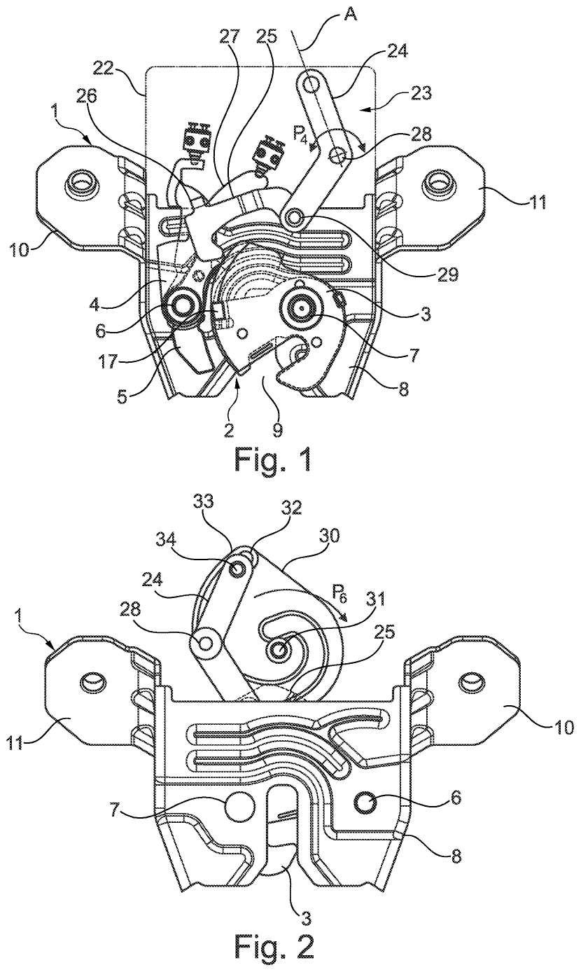

FIG. 1 is a plan view of a motor vehicle lock equipped according to the invention, with a locking mechanism in an open position, wherein only the components substantial for explaining the invention are shown,

FIG. 2 is a view of the rear of the motor vehicle lock according to FIG. 1 as a view of the lock case, the closure lever and a cam disk in an open position,

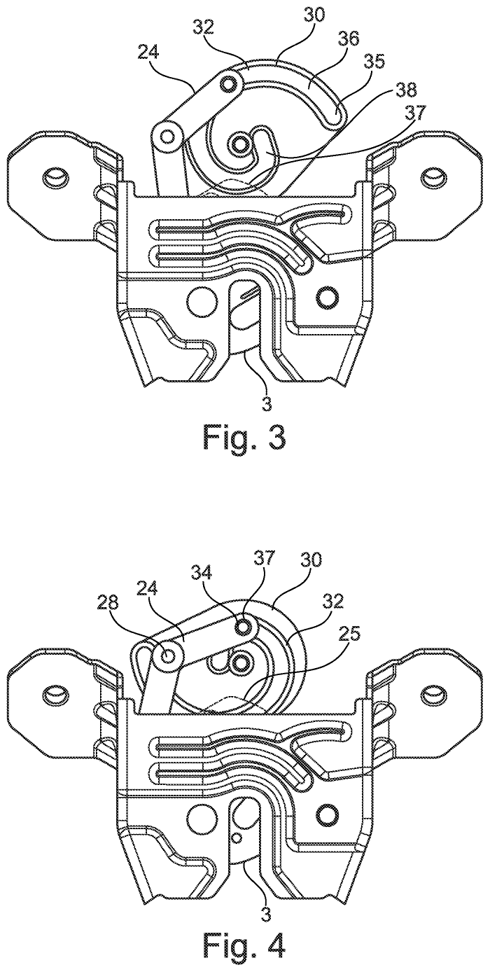

FIG. 3 shows the motor vehicle lock designed according to the invention according to FIG. 2, wherein the cam disk is shown during a closure process, and

FIG. 4 shows the closure process and the position of the cam disk or the closure lever in a main latch position of the locking mechanism.

In FIG. 1, a motor vehicle lock 1 is shown in a plan view of a locking mechanism 2 in an opened—that is, unblocked—position. The locking mechanism has a rotary latch 3, a pre-latch pawl 4 and a main latch pawl 5. The locking mechanism parts 3, 4, 5 are pivotably mounted in a lock case 8 by means of axles 6, 7. The lock case 8 has an insertion region 9 through which a lock holder (not shown) can interact with the rotary latch 3 in a known manner. The lock case 8 also has brackets 10, 11, by means of which the motor vehicle lock 1 can be fastened to a motor vehicle or a body of the motor vehicle. To explain the invention, only some components of the motor vehicle lock 1 which are essential for explaining the invention are shown. The pawls 4, 5 have extensions 12, 13, each being engageable with a switch device 14, 15. The switching means 14, 15 are shown in FIG. 1 in an actuated position. In other words, the extension 12 of the pre-latch pawl actuates the switch device 14 and the extension 13 of the main latch pawl 5 actuates the switch device 15. In this embodiment, both switch devices 14, 15 are designed as microswitches and are shown actuated.

FIG. 1 shows an unlocked position of the locking mechanism 2, so that the rotary latch 3 is able to move in the direction of the arrow P, i.e., counterclockwise. The movement of the rotary latch 3 is effected by a rotary latch spring (not shown), which loads the rotary latch 3 in the direction of the arrow P, and by a sealing pressure exerted by a tailgate on the vehicle lock or the lock holder. In this open position, the rotary latch is able to release the lock holder and a tailgate can be opened. The axes 6, 7 of the locking mechanism 2 are accommodated in the lock case 8, wherein an inlet area 9 forms a recess in the lock case 8 to enable insertion of the lock holder. By means of the bracket 10, 11, the motor vehicle lock 1 can be mounted in the motor vehicle.

In addition to the locking mechanism already explained, the motor vehicle lock 1 has a closure device 23, wherein only a closure lever 24 and a closure pawl 25 of the closure device 23 are shown. The closure pawl 25 is in a decoupled position, wherein a driver 26 on the closure pawl 25 engages the pre-latch pawl 4. To actuate the closure pawl 25, the pre-latch pawl 4 has a driving contour 27 into which the driver 26 of the closure pawl 25 engages. In this exemplary embodiment, the closure pawl 25 is arranged above the pre-latch pawl 4, and the driver 26 extends in the direction of the pre-latch pawl 4, so that an interaction between the driver 26 and the driver contour 27 is possible.

The closure lever 24 is mounted in the motor vehicle lock 1 so as to be pivotable about its axis 28, wherein the axis 28 is arranged in a fixed position in the motor vehicle lock 1. Thus, the closure lever 24 is able to pivot about the axis 28 in the direction of the arrow P4 and to move the closure pawl 25 accordingly. For this purpose, the closure pawl 24 is accommodated in the closure lever 24 so as to be pivotable about the axis 29.

The closure lever 24 is shown in its initial position A, wherein the initial position is indicated by the dash-dotted line. The initial position designates the position of the closure lever 24, in which the closure pawl 25 is decoupled from the rotary latch 3 or in which the closure pawl 25 is able to engage in the movement region of the rotary latch and in particular in the pre-latch 17. However, the closure pawl 25 is held out of engagement with the pre-latch 17 or the rotary latch 3 by means of the driver 26 and in interaction with the pre-latch pawl 4.

In FIG. 2, the motor vehicle lock 1 according to FIG. 1 is shown in a rear view as a view of the lock case 8, wherein a cam disk 30 is additionally shown. The cam disk is rotatable about its axis 31, wherein the cam disk 30 is arranged in a fixed position in the motor vehicle lock 1. On the cam disk there is a guide contour 32 which extends from a radial end 33 towards the axis of rotation 31 of the cam disk 30 and is formed helically on the cam disk 30. The closure lever 24 arranged in a fixed position in the motor vehicle lock 1 is in engagement with the closure pawl 25 on one side and has a drive bolt 34 which is guided in the guide contour 32 of the cam disk 30.

FIG. 4 shows the position of the closure lever 24, which the closure lever 24 assumes when the pre-latch position has not yet been assumed. The open position of the closure drive is accordingly shown, wherein the closure pawl 25, the closure lever 24, as well as the cam disk 30 and an electric motor (not shown) with a downstream gear mechanism are noted as the substantial components of the closure drive. In order to be able to initiate closing starting from the release position of the closure pawl 25, the cam disk is moved clockwise around the axis 31 in the direction of the arrow P6, whereby the closure pawl is able to fall into the pre-latch 17 of the rotary latch 3.

FIG. 3 shows the closure process by means of the cam disk 30, the closure lever 24 and the closure pawl 25. The guide contour 32 on the cam disk 30 can also be seen. The guide contour 32 runs helically from a radially outer region 33 of the cam disk 30 towards the axis 31 of the cam disk 30. The guide contour 32 has a first position 35 which can be designated as the open position, a second position 36 which can be designated as the parking position, and starting position for closing, a main latch position 37 in which the rotary latch 3 would have reached the main latch, and an overtravel position 38 in which the rotary latch has been pivoted beyond the main latch position in order to enable secure engagement when the locking mechanism 2 is electrically latched. Due to the spiral or helical course of the guide contour 32, the introduction of force into the rotary latch 3 changes, wherein an increase in force or an increase in torque can be achieved starting from the radial end 33 of the cam disk towards the overtravel position 38. The present FIG. 3 accordingly shows the movement of the cam disk and the position of the closure lever 24 during the transfer of the rotary latch 3 from the pre-latch position to the main latch position.

In FIG. 4, the cam disk 30 has moved the closure lever 24 so far that the rotary latch 3 has reached the main latch position. The drive bolt 34 is in the main latch position of the guide contour 32. As can be clearly seen in FIG. 2 to 4, the cam disk changes the engagement of the closure lever 24 on the cam disk 30 so that a variable torque can be introduced into the closure pawl 25 or the rotary latch 3. The design according to the invention therefore makes it possible to introduce a variable torque into the rotary latch and to provide a high force for closing the door, sliding door or tailgate. A high closure force is required in particular in the region where the main latch position 37 is reached since here the overall sealing forces act against the tailgate, door or sliding door.

### LIST OF REFERENCE SIGNS

1 motor vehicle lock
2 locking mechanism
3 rotary latch
4 pre-latch pawl
5 main latch pawl
6, 7, 28, 29, 31 axis
8 lock cases
9 insertion region
10, 11 brackets
16 latch holder
17 pre-latch
18 metal main body
19 plastic sheath
21 main latch
22 housing
23 closure device
24 closure lever
25 closure pawl
26 driver
27 driving contour
30 cam disk
32 guide contour
33 radial end
34 drive bolts
35 open position
36 pre-latch position
37 main latch position
38 overtravel position
P4, P5 arrow

1. A lock for a motor vehicle comprising:
a closure device including a closure pawl,
a locking mechanism including a rotary latch, a pre-latch pawl, and a main latch pawl,
wherein the rotary latch includes a metal main body and is latchable in a pre-latch position and a main latch position,
the pre-latch position of the rotary latch being formed by a region arranged on the metal main body of the rotary latch, and
wherein the angled region is engageable with the closure pawl of the closure device.

2. The lock for a motor vehicle according to claim 1, wherein the closure device is configured to act on the rotary latch with a variable closure force.

3. The lock for a motor vehicle according to claim 1, wherein the closure device further includes a stationary closure lever, and the closure pawl is arranged pivotably on the stationary closure lever.

4. The lock for a motor vehicle according to claim 3, further comprising a cam disk, wherein the closure lever is configured to be driven by the cam disk.

5. The lock for a motor vehicle according to claim 3, wherein the closure lever introduces an increasing closure force into the closure pawl during closing.

6. The lock for a motor vehicle according to claim 4, wherein the cam disk is integrated into the lock for a motor vehicle.

7. The lock for a motor vehicle according to claim 4, wherein the cam disk includes a guide contour for the closure lever.

8. The lock for a motor vehicle according to claim 7, wherein a keyed fit is disposed between the guide contour and the closure lever.

9. The lock for a motor vehicle according to claim 4, wherein the cam disk has a center position corresponding to a pre-latch position for the closure pawl.

10. The lock for a motor vehicle according to claim 4, wherein the rotary latch is configured to be moved into an overtravel position from the pre-latch position by the cam disk.

11. The lock for a motor vehicle according to claim 4 further comprising a housing, wherein the cam disk is integrated into the housing.

12. The lock for a motor vehicle according to claim 9, wherein the center position is a parking position, and wherein the closure pawl in the parking position is configured to fall into the locking mechanism.

13. The lock for a motor vehicle according to claim 4, wherein the cam disk is configured to introduce a variable torque into the closure lever.

14. The lock for a motor vehicle according to claim 4 further comprising an electric motor configured to drive the cam disk.

15. The lock for a motor vehicle according to claim 14, further comprising a worm gear stage disposed between the electric motor and the cam disk.
